(19) United States
(12) Patent Application Publication
(10) Pub. No.: US 2007/0147640 A1
(43) Pub. Date: Jun. 28, 2007

(54) Audio accessory and method

(76) Inventors: Matthew D. Mottier, Lake Zurich, IL (US); Dennis J. Budnick, Richmond, IL (US); Joel A. Clark, Woodridge, IL (US); Joseph C. Dwyer, Downers Grove, IL (US); Nicholas M. Klezek, Wheeling, IL (US)

Correspondence Address: MOTOROLA INC, 600 NORTH US HIGHWAY 45, ROOM AS437, LIBERTYVILLE, IL, 60048-5343, US

(21) Appl. No.: 11/319,670

(22) Filed: Dec. 28, 2005

(51) Int. Cl. H04R 3/00

(52) U.S. Cl. 381/111; 381/122

(57) ABSTRACT

An audio accessory (100) and corresponding method for operating the audio accessory are provided. The audio accessory includes a first speaker, a second speaker, a microphone, and a multiplexer circuit for multiplexing the second speaker with the microphone. The audio accessory is suitable for use with an electronic device (200), capable of playing an audio file and/or receiving an audio input from the audio accessory.

### FIELD OF THE DISCLOSURE

The present disclosure relates generally to audio devices, and more particularly to operating audio accessories, for example, a headphone with a microphone.

### BACKGROUND

Electronic devices are used to perform a wide variety of functions including playing games, playing audio and video files, Internet browsing, and sending and receiving messages. Examples of the electronic devices include, but are not limited to, mobile phones, laptops, Personal Digital Assistants (PDAs), Personal Computers (PCs), and portable audio players. Many electronic devices that play audio files are capable of connecting to audio devices and audio accessories that enable users to listen to the audio files. Examples of such audio devices include, but are not limited to, headsets, headphones, and earphones.

An audio accessory can be connected to an electronic device using a jack-and-plug arrangement. A jack is often provided in the electronic device into which an appropriate plug of the audio accessory can be mechanically and electrically coupled. There are different types of jacks, for example, 3.5 mm three-pole jacks and 2.5 mm four-pole jacks, for connecting audio accessories to electronic devices. An audio accessory with a single 3.5 mm three-pole jack is capable of providing a stereo audio output when connected to an electronic device for, example, a portable audio player. However, an audio accessory with the single 3.5 mm three-pole jack does not support a microphone audio input.

Some audio accessories include a single 2.5 mm four-pole jack which is capable of supporting both an audio output and a microphone audio input when used with an electronic device, for example, a mobile telephone. These accessories enable users of mobile phones to listen to music and to make and receive calls in a hands-free manner. However, due to limited number of electronic devices supporting audio accessories having a 2.5 mm four-pole plug, these accessories cannot be used with a wide variety of electronic devices. Also, many users are unable to use audio accessories having 3.5 mm three-pole plug with an electronic device supporting only a 2.5 mm four-pole jack.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an audio accessory.

FIG. 2 illustrates an electronic device.

FIG. 3 illustrates communication between an audio accessory and an electronic device.

FIG. 4 illustrates communication between an audio accessory and an electronic device.

FIG. 5 illustrates communication between an audio accessory and an electronic device.

FIG. 6 is a process flow diagram.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### DETAILED DESCRIPTION

The present disclosure pertains generally to operating an audio accessory including one or more speakers and a microphone. The audio accessory is capable of being connected to an electronic device, for example, a mobile phone, personal digital assistant (PDA), personal computer or other electronics device.

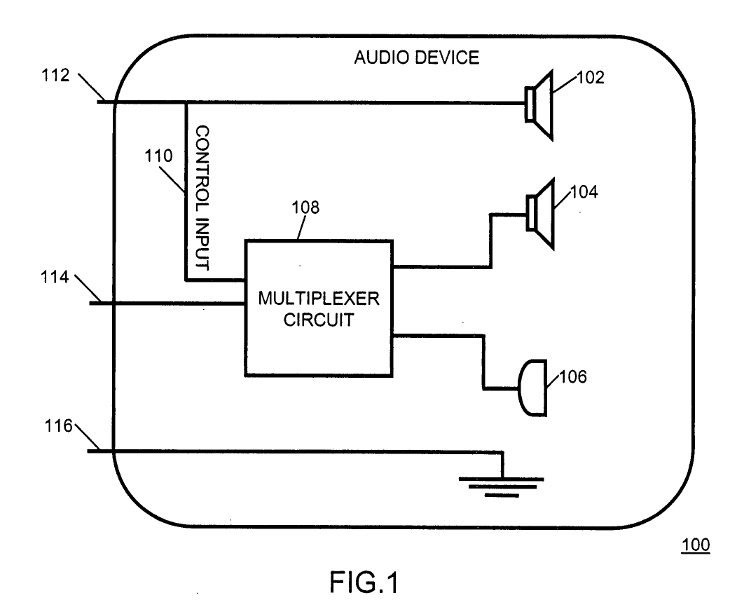

FIG. 1 is an illustrative audio accessory 100 comprising generally a first speaker 102, a second speaker 104, a microphone 106, and a multiplexer circuit 108. The audio accessory further comprises a first conductor 112 coupled to the first speaker 102, a second conductor 114, coupled to the multiplexer circuit 108 and a third conductor 116, connected to the ground. Examples of audio accessories are discussed hereinabove. The multiplexer circuit 108 multiplexes a speaker, for example, the second speaker 104 in FIG. 1, with the microphone 106. The multiplexer circuit 108 can be used to switch the audio accessory 100 between stereo and mono mode configurations.

In the stereo mode configuration, stereo audio signals are provided to the first speaker 102 and to the second speaker 104. In the mono mode configuration, a mono audio signal is provided to the first speaker 102 and/or to the second speaker 104. Further, in the mono mode, the microphone 106 is activated for use. In one embodiment, the multiplexer circuit 108 multiplexes the second speaker 104 with the microphone 106 in the mono mode configuration. The multiplexer circuit includes one or more controllers or switches for multiplexing the second speaker 104 and the microphone 106. Examples of the one or more controllers include, but are not limited to, Field Effect Transistors (FETs), Metal Oxide Semiconductor Field Effect Transistors (MOSFETs), Bipolar Junction Transistors (BJTs), relays and CMOS analog switches.

The multiplexer circuit 108 is operated using a control signal, provided from an electronic device (not shown in FIG. 1) capable of connecting to the audio accessory 100. The control signal enables the multiplexer circuit 108 to switch the audio accessory 100 between the stereo and mono mode configurations. The control signal is transmitted to the multiplexer circuit 108 through a control input 110. The control input 110 is coupled with the first conductor 112. Further, the first conductor 112 is connected to the first speaker 102 and is used to transmit the audio signal to the first speaker 102 from the electronic device. In the stereo mode, the second conductor 114 is connected to the multiplexer circuit 108 and is used to transmit an audio signal to the second speaker 104 from the electronic device. In the mono mode, the second conductor 114 transmits an audio signal from the microphone 106 to the electronic device.

In one embodiment, in the stereo mode configuration, a stereo audio signal is received by the first speaker 102 and the second speaker 104 from the electronic device, via the first conductor 112 and the second conductor 114, respectively. Further, as both the first conductor 112 and the second conductor 114 are used for transmitting the stereo audio signal, microphone audio is not supported in the stereo mode. In this embodiment, the microphone is disabled in stereo mode.

In another embodiment, in the mono mode configuration, a mono audio signal is provided to the first speaker 102 and/or to the second speaker 104 from the electronic device. In the mono mode, a conductor, for example, the first conductor 112 transmits the mono audio signal to the first speaker 102 and/or to the second speaker 104. In this embodiment, the second conductor 114 is used to receive an audio signal from the microphone 106.

In one embodiment, the first conductor 112, the second conductor 114, and the third conductor 116 are coupled to a three-pole jack, for example, a 3.5 mm three-pole plug. The three-pole plug is used to connect the audio accessory with an electronic device via a complementary jack.

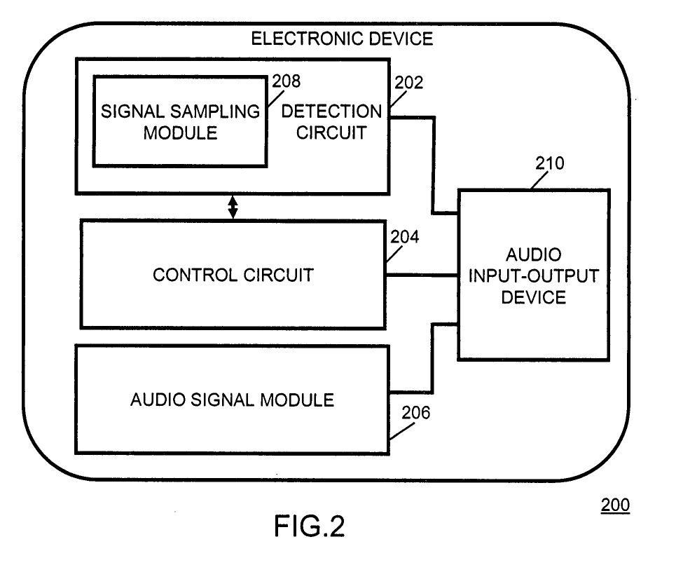

FIG. 2 is an illustrative electronic device 200 that includes a detection circuit 202, a control circuit 204 coupled to the detection circuit 202, and an audio signal module 206. The detection circuit 202 is coupled to an audio input-output device 210. In one embodiment, the audio input-output device is a 3.5 mm three-pole jack capable of connecting to a 3.5 mm three-pole plug. The detection circuit 202 also includes a signal sampling module 208. The detection circuit 202, the control circuit 204, and the audio signal module, send and receive signals from the electronic device 100, through the audio input-output device 210.

In one embodiment, the electronic device 200 of FIG. 2 is interfaced with an audio accessory, for example, the audio accessory 100 in FIG. 1, via the audio input-output device 210 in FIG. 2. The electronic device 200 can receive and/or transmit audio signals to the audio accessory through the audio input-output device 210. When the audio accessory is connected to the electronic device 200, the detection circuit 202 detects the audio accessory by sampling a device-detect signal. To determine whether an audio accessory connected to the electronic device 200 is a valid audio accessory, the signal sampling module 208 samples a load-detect signal. The load-detect signal sample values are then compared with predefined sample values, to identify the valid audio accessory.

Once the valid audio accessory is detected and identified, the control circuit 204 sends a control signal to select either the stereo or mono mode configuration. The selection of the stereo or mono mode can be based on many factors. For example, when a user of a mobile phone is using the mobile phone for listening to music using a headset, stereo mode is activated. In case the user has to make or receive a call from the mobile phone using the headset, the mono mode can be selected, wherein a microphone of the headset is activated for use. After selection of the stereo or mono mode, the audio signal module 206 provides audio signals to the audio input-output device 210. The audio signals are further transmitted to the audio accessory 100, through the audio input-output device 210. In one embodiment, the audio signal module 206 provides mono audio signals to the audio input-output device 210 when the mono mode is selected. Further, the audio signal module 206 also receives an audio signal from the microphone 106 of the audio accessory 100 when the mono mode is selected. In another embodiment, the audio signal module 206 provides stereo audio signals to the audio input-output device 210 when the stereo mode is selected.

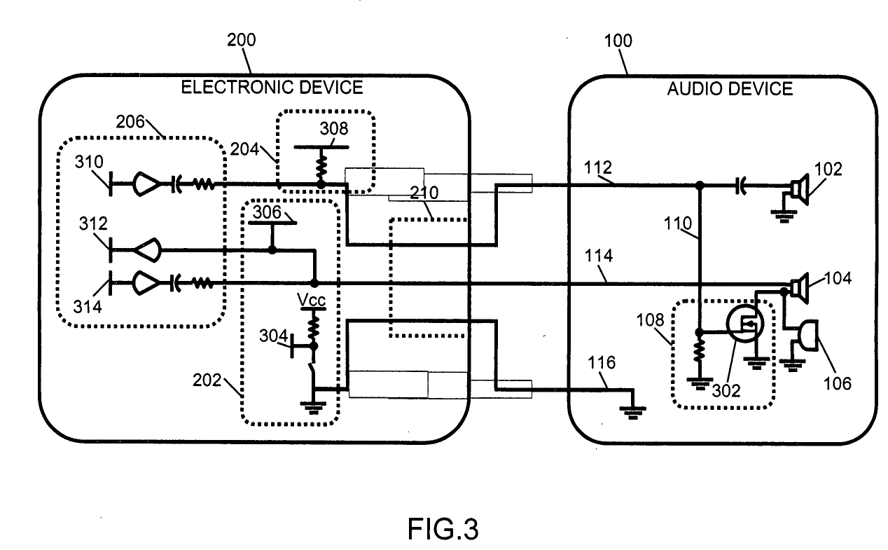

FIG. 3 illustrates a communication between the audio accessory 100 and the electronic device 200 in accordance with another embodiment. The audio accessory is connected to the electronic device using the first conductor 112, the second conductor 114, and the third conductor 116. The audio accessory 100 includes a Field Effect Transistor (FET), for example, an N-Channel Field Effect Transistor (NFET) 302, in the multiplexer circuit 108. The NFET 302 multiplexes a speaker, for example, the second speaker 104 with the microphone 106. The gate of the NFET 302 is coupled to the control input 110. The drain of the NFET 302 is coupled to the microphone 106 and the second speaker 104. The source of the NFET 302 is grounded. The electronic device includes a load-detect signal input 306 that detects a load-detect signal, in the detection circuit 202 and a device-detect signal input 304 that detects a device-detect signal in the signal sampling module of the detection circuit 202. The control circuit 204 includes a control signal output 308 that transmits a control signal. Further, the audio signal module 206 includes a first speaker output 310, a microphone input 312, and a second speaker output 314. The electronic device 200 and the audio accessory 100 are interfaced at the audio input-output device 210.

In one embodiment, in FIG. 3, when an audio accessory is connected to the electronic device, a mechanical switch arrangement coupled to a voltage supply Vcc, in the detection circuit 202, causes a change in value of the device-detect signal. The device-detect signal input 304 thus detects when the audio accessory is connected to the electronic device 200. After detection of the audio accessory, the load-detect signal 306 is sampled to determine whether the audio accessory is a valid accessory. The load-detect signal is sampled once when the control signal is enabled to provide a first sample value. The load-detect signal is sampled again when the control signal is disabled to provide a second sample value. If the first sample value is less than or equal to a first predefined value, for example, 0.1 volts, and the second sample value is greater than or equal to a second predefined value, for example, 1.0 volt, then the audio device is identified as the valid audio device. An example of the valid audio accessory is shown in FIG. 1 as the audio accessory 100. An exemplary sampling rate could be 3 samples at an interval of 5 ms between each sample, although other sampling rates may be used alternatively.

When the audio accessory has been detected and identified as a valid accessory, the control signal output 308 is used to select either the stereo mode or the mono mode configuration. The control signal is transmitted to the first conductor 112 through the audio input-output device 210. This control signal is transmitted to the gate of the NFET 302 using the control input 110.

In one embodiment, the control signal is set to a first value, for example, a low voltage value (relative to the second control signal values discussed below), for selecting the mono mode configuration. An exemplary low voltage value is 0 Volts. The low voltage control signal produces high impedance in the NFET 302 channel, which decouples the speaker, for example, the second speaker 104 in FIG. 3, from the ground. As a result, the second speaker 104 and the microphone 106 are coupled to the second conductor 114 in series. In this embodiment, the second speaker 104 is disabled and an audio signal from the microphone 106 can be transmitted through the second conductor 114. The second conductor 114 transmits the audio signal from the microphone 106 to the audio input-output device 210. The audio input-output device 210 transmits the audio signal from the microphone 106 to the microphone input 312, in the audio signal module 206. The audio signal from the microphone 106 is amplified using an amplifier before being fed to the microphone input 312. In the mono mode, a mono audio signal from the first speaker output 310 is transmitted to the audio input-output device 210. The mono audio signal is amplified, using an amplifier, and filtered, using a resistor and a capacitor in series, before being transmitted to the audio input-output device 210. Thereafter, the audio input-output device 210 transmits the mono audio signal to the first speaker 102 through the first conductor 112. Moreover, the second speaker output 314, in the audio signal module 206, is disabled in the mono configuration.

In another embodiment, the control signal is set to a second value, for example, a relatively high voltage value (relative to the first control signal value discussed above) for selecting the stereo mode. An exemplary high voltage value is 2.6 Volts. The high voltage control signal produces low impedance in the NFET 302 channel that couples the speaker, for example, the second speaker 104 in FIG. 3, to ground. As a result, microphone 106 is shorted out. Thus the second speaker 104 is enabled and the microphone 106 is disabled. In the stereo mode, the first speaker output 310 and the second speaker output 314, in the audio signal module 206, transmits stereo audio signals to the audio input-output device 210. The stereo audio signals from the first speaker output 310 and the second speaker output 314 are amplified, using an amplifier, and filtered, using a resistor and a capacitor in series, before being transmitted to the audio input-output device. The audio input-output device 210 transmits the stereo audio signals to the first speaker 102 and the second speaker 104 through the first conductor 112 and the second conductor 114, respectively. The microphone input 312 is disabled during the stereo mode configuration.

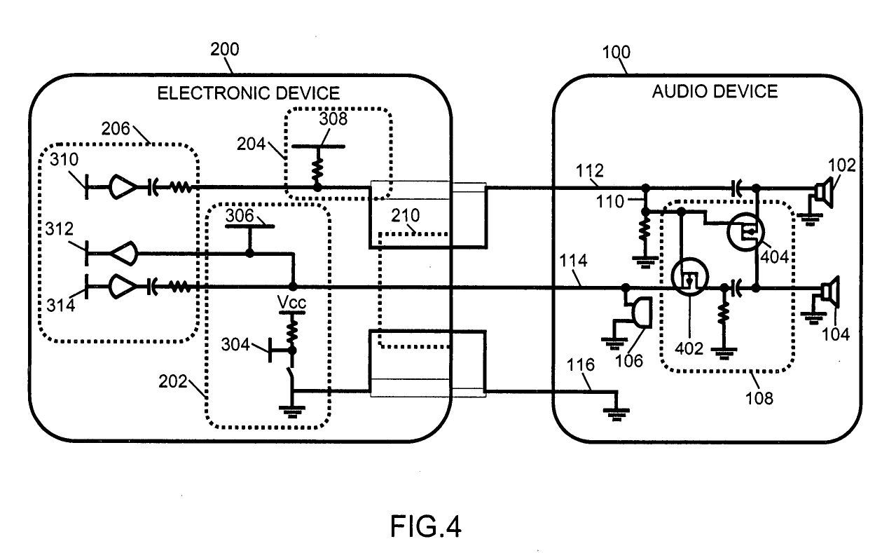

FIG. 4 illustrates a communication between the audio accessory 100 and the electronic device 200 in accordance a second embodiment. The audio accessory 100 includes two Field Effect Transistors (FETs), for example, a P-Channel Field Effect Transistor (PFET) 402 and an N-Channel Field Effect Transistor (NFET) 404, in the multiplexer circuit 108. The PFET 402 multiplexes the second speaker 104 with the microphone 106 and the NFET 404 multiplexes the first speaker 102 with the second speaker 104. The gate of the PFET 402 is coupled to the first conductor 112. Further, the source of the PFET 402 is coupled to the microphone 106 and the drain of the PFET 402 is coupled to the second speaker 104. The gate of the NFET 404 is coupled to the first conductor 112. Further, the source of the NFET 404 is coupled to the first speaker 102 and the drain of the NFET 404 is coupled to the second speaker 104. The PFET 402 and the NFET 404 are operated by the control signal transmitted from the control circuit 204 in the electronic device 200, through the control input 110.

In one embodiment, when an audio accessory is connected to the electronic device 200, a mechanical switch arrangement coupled to a voltage supply Vcc, in the detection circuit 202, causes a change in value of the device-detect signal. Hence, the device-detect signal input 304 detects whether the audio accessory is connected to the electronic device 200. After detection of the audio accessory, the load-detect signal 306 is sampled to determine whether the audio accessory is a valid audio accessory. The load-detect signal is sampled once when the control signal is enabled to provide a first sample value. The load-detect signal is sampled again when the control signal is disabled to provide a second sample value. If the first sample value is greater than or equal to a first predefined value, for example, 1.7 volts, and the second sample value is less than or equal to a second predefined value, for example, 0.6 volts, then the audio accessory is identified as being valid. An example of the valid audio accessory is shown in FIG. 1 as the audio accessory 100. An exemplary sampling rate could be 3 samples at an interval of 5 ms between each sample, although other sampling rates may be used alternatively.

When the audio accessory has been detected and identified as a valid accessory, the control signal is used to select either the stereo or mono mode configuration for the audio accessory. The control signal is transmitted to the first conductor 112 through the audio input-output device 210. This control signal is transmitted to the gate of the PFET 402 and the NFET 404 using the control input 110.

In one embodiment, the control signal is set to a first value, for example, a high value relative to a second value discussed below, for selecting the mono mode. An exemplary high values is 2.6 Volts. The high voltage control signal causes high impedance in the PFET 402 channel that decouples the second speaker 104 from the second conductor 114, thus activating the microphone. In this embodiment, the second speaker 104 is disabled and an audio signal from the microphone 106 can be transmitted through the second conductor 114. The second conductor 114 transmits the audio signal from the microphone 106 to the audio input-output device 210. The audio input-output device 210 transmits the audio signal from the microphone 106 to the microphone input 312, in the audio signal module 206. Further, the audio signal from the microphone 106 is amplified using an amplifier before being fed to the microphone input 312. The control signal at the first value causes low impedance in the NFET 404 channel. Due to the low impedance in the NFET 404 channel, the second speaker 104 gets coupled with the first conductor 112. As a result, the first conductor 112 can be used to transmit a mono audio signal to the first speaker 102 and the second speaker 104. The mono audio signal from the first speaker output 310 is transmitted to the audio input-output device 210. The mono audio signal is amplified, using an amplifier, and filtered, using a resistor and a capacitor in series, before being transmitted to the audio input-output device 210. Thereafter, the audio input-output device 210 transmits the mono audio signal to the first speaker 102 and the second speaker 104, through the first conductor 112. Moreover, the second speaker output 314, in the audio signal module 206, is disabled during the mono mode of operation.

In another embodiment of the present invention, the control signal is set to a second value, for example, a low value relative to the high value discussed above, for selecting the stereo mode. An exemplary low value is 0 Volts. The low voltage produces low impedance in the PFET 402 channel that couples the second speaker 104 to the second conductor 114. In this embodiment, the second speaker 104 is enabled and the microphone 106 is disabled. Moreover, the control signal at the second value causes a high impedance in the NFET 404 channel. Due to the high impedance in the NFET 404 channel, the second speaker 104 gets decoupled from the first speaker 102. As a result, the first conductor 112 can be used to transmit a stereo audio signal to the first speaker 102 and the second conductor 114 can be used to transmit the stereo audio signal to the second speaker 104. In the stereo mode, the first speaker output 310 and the second speaker output 314, in the audio signal module 206, transmits stereo audio signals to the audio input-output device 210. The stereo audio signals from the first speaker output 310 and the second speaker output 314 are amplified, using an amplifier, and filtered, using a resistor and a capacitor in series, before being transmitted to the audio input-output device. The audio input-output device 210 transmits the stereo audio signals to the first speaker 102 and the second speaker 104 through the first conductor 112 and the second conductor 114 respectively. Further, the microphone input 312 is disabled during the stereo mode of operation.

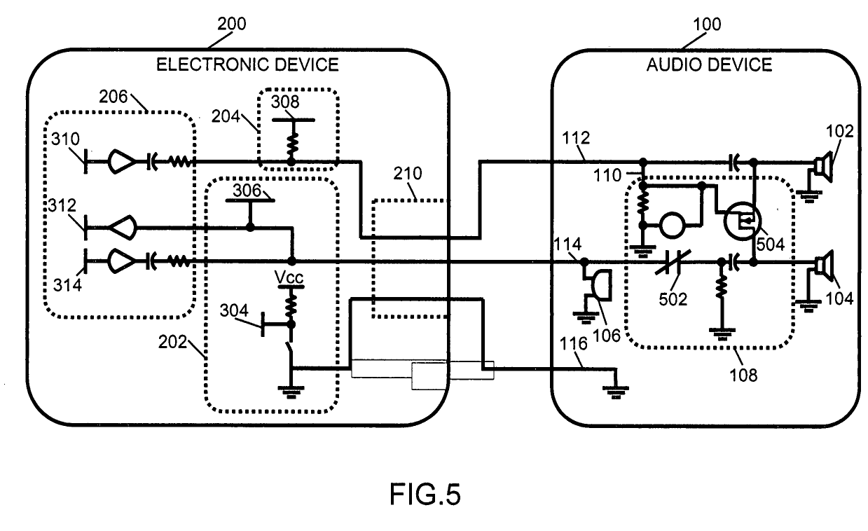

FIG. 5 illustrates a communication between the audio accessory 100 and the electronic device 200 in accordance a third embodiment of the present invention. The audio accessory 100 includes a relay, for example, a Normally-Closed (NC) relay 502 and a Field Effect Transistor (FET), for example, an N-Channel Field Effect Transistor (NFET) 504, in the multiplexer circuit 108. In an embodiment of the present invention, the NC relay 502 multiplexes a speaker, for example, the second speaker 104 with the microphone 106 and the NFET 504 multiplexes the first speaker 102 with the second speaker 104. The electromagnet of the NC relay 502 and the gate of the NFET 504_is coupled to a conductor, for example, the first conductor 112. Further, the switch of the NC relay 502 is coupled with the microphone 106 and a speaker, for example, the second speaker 104. The source of the NFET 504 is coupled with the first speaker 102 and the drain of the NFET 504 is coupled to the second speaker 104. The NC relay 502 and the NFET 504 are operated by the control signal transmitted from the control circuit 204 in the electronic device 200, through the control input 110.

In one embodiment, when an audio accessory is connected to the electronic device 200, a mechanical switch arrangement coupled to a voltage supply Vcc, in the detection circuit 202, causes a change in value of the device-detect signal. Hence, the device-detect signal input 304 detects whether the audio accessory is connected to the electronic device 200. After detection of the audio accessory, the load-detect signal 306 is sampled to determine whether the audio accessory is a valid audio accessory, for example, the audio accessory 100. The load-detect signal is sampled once when the control signal is enabled, to provide a first sample value. The load-detect signal is sampled again when the control signal is disabled, to provide a second sample value. If the first sample value is greater than or equal to a first predefined value, for example, 1.7 volts, and the second sample value is less than or equal to a second predefined value, for example, 0.6 volts, then the audio accessory is identified as the valid audio accessory. An example of the valid audio accessory is shown in FIG. 1 as the audio accessory 100.

When the audio accessory 100 has been detected and identified as the valid audio accessory, the control signal is used to select either a stereo mode or a mono mode for operating the audio accessory 100. The control signal is transmitted to the first conductor 112 through the audio input-output device 210. This control signal is transmitted to the electromagnet of the NC relay 502 and the gate of the NFET 504, using the control input 110.

In one embodiment, the control signal is set to a first value, for example, a high value for selecting the mono mode. This causes the switch of the NC Relay 502 coupling the microphone 106 with a speaker, for example, the second speaker 104 to open. As a result, the second speaker 104 gets decoupled from the microphone 106 and the second conductor 114. In this embodiment, a speaker, for example, the second speaker 104 is disabled and the microphone 106 is enabled, and an audio signal from the microphone 106 can be transmitted through the second conductor 114. The second conductor 114 transmits the audio signal from the microphone 106 to the audio input-output device 210. The audio input-output device 210 transmits the audio signal from the microphone 106 to the microphone input 312, in the audio signal module 206. Further, the audio signal from the microphone 106 is amplified using an amplifier before being fed to the microphone input 312. Moreover, the control signal at the first value causes a low impedance in the NFET 504 channel. Due to the low impedance in the NFET 504 channel, the second speaker 104 gets coupled with the first conductor 112. As a result, the first conductor 112 can be used to transmit a mono audio signal to the first speaker 102 and the second speaker 104. The mono audio signal from the first speaker output 310 is transmitted to the audio input-output device 210. The mono audio signal is amplified, using an amplifier, and filtered, using a resistor and a capacitor in series, before being transmitted to the audio input-output device 210. Thereafter, the audio input-output device 210 transmits the mono audio signal to the first speaker 102 and the second speaker 104, through the first conductor 112. Moreover, the second speaker output 314, in the audio signal module 206, is disabled in the mono mode configuration.

In another embodiment, the control signal is set to a second value, for example, a low value for selecting the stereo mode. This deactivates the electromagnet of the NC Relay 502. As a result, the switch of the NC Relay 502 couples a speaker, for example, the second speaker 104 to the second conductor 114. In this embodiment, a speaker, for example, the second speaker 104 is enabled and the microphone 106 is disabled. Moreover, the control signal at the second value causes a high impedance in the NFET 504 channel. Due to the high impedance in the NFET 504 channel, the second speaker 104 gets decoupled from the first speaker 102. As a result, the first conductor 112 can be used to transmit a stereo audio signal to the first speaker 102 and the second conductor 114 can be used to transmit the stereo audio signal to the second speaker 104. In the stereo mode, the first speaker output 310 and the second speaker output 314, in the audio signal module 206, transmits stereo audio signals to the audio input-output device 210. The stereo audio signals from the first speaker output 310 and the second speaker output 314 are amplified, using an amplifier, and filtered, using a resistor and a capacitor in series, before being transmitted to the audio input-output device. The audio input-output device 210 transmits the stereo audio signals to the first speaker 102 and the second speaker 104 through the first conductor 112 and the second conductor 114 respectively. Further, the microphone input 312 is disabled during the stereo mode of operation.

In one embodiment of the present invention, the electronic device 200 can be used with an audio headset coupled to a 2.5 mm, four-pole jack, instead of a 3.5 mm, three-pole jack, as in audio accessory 100, using an adapter device. The adapter device connects to the audio headset using four conductors. Further, the adapter device connects to the electronic device 200 using three conductors. The adapter device is detected by the electronic device before the electronic device streams audio signals to the audio headset through the adapter device.

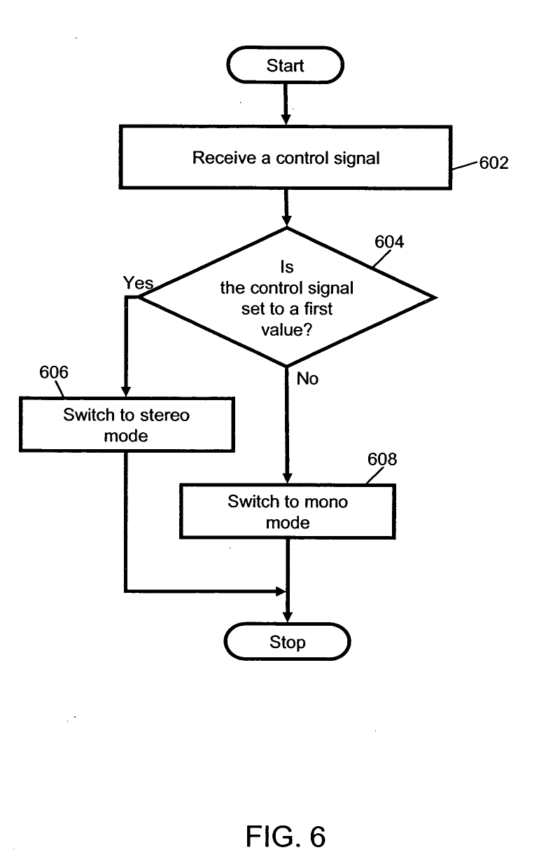

FIG. 6 is an exemplary process flow diagram and illustrates a method for operating the audio accessory 100. The audio accessory 100 can be operated in one of, a stereo mode and a mono mode using the control signal. At step 602, the control signal is received by the audio accessory 100. In an embodiment of the present invention, the control signal can be set either to a first value or a second value. At step 604, it is determined whether the control signal is set to the first value. If, at step 604, it is determined that the control signal is set to the first value, then at step 606, a stereo mode is activated. In an embodiment of the present invention, during the stereo mode, a stereo signal is provided to first speaker 102 and the second speaker using the first conductor 112 and the second conductor 114 respectively. If, at step 604, it is determined that the control signal is not set to the first value, then at step 608, a mono mode is activated. In an embodiment of the present invention, during the mono mode, a mono audio signal is provided to one speaker, for example, the first speaker 102 using a conductor, for example, the first conductor 112. In another embodiment of the present invention, the mono audio signal is provided to both the, first speaker 102 and the second speaker 104 using a conductor, for example, the first conductor 112. Further, an audio signal from the microphone 106 is provided to the second conductor 114.

The embodiments described above have the advantage of providing an audio accessory having capabilities to support a stereo audio and an audio from a microphone over three conductors. Further, the audio accessory can be interchangeably used with electronic devices like, mobile phones and personal computers. Also, users will be able to use their favorite audio accessories having a 3.5 mm three-pole jack with electronic devices like mobile phones.

It will be appreciated that embodiments of the disclosure described herein may be comprised of one or more conventional processors and unique stored program instructions that control the one or more processors to implement, in conjunction with certain non-processor circuits, some, most, or all of the functions of detecting and identifying an audio accessory, and operating the audio accessory, described herein. The non-processor circuits may include, but are not limited to, an audio signal input-output device, a three conductor cable, mechanical switches, biasing circuits, power source circuits, and interfacing devices. As such, these functions may be interpreted as steps of a method to operate the audio accessory. Alternatively, some or all functions could be implemented by application specific integrated circuits (ASICs), in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the invention, which is to be limited not by the exemplary embodiments but by the appended claims.

What is claimed is:

1. An audio accessory suitable for use with an electronic device, the audio accessory comprising:
a first speaker;
a second speaker;
a microphone; and
a multiplexer circuit coupled to the second speaker and the microphone, wherein the multiplexer circuit multiplexes the microphone with the second speaker.

2. The audio accessory of claim 1, wherein the multiplexer circuit comprises a controller for multiplexing the microphone with the second speaker, the controller for configuring the audio accessory in a stereo mode configuration or in a mono mode configuration.

3. The audio accessory of claim 2, in the stereo mode configuration, the microphone is decoupled from the second speaker.

4. The audio accessory of claim 2, wherein in the mono mode configuration, the microphone is coupled to the second speaker.

5. The audio accessory of claim 2, the controller is operated by a control signal transmitted through a control input, the control input coupled to the first speaker.

6. An audio accessory capable of being connected to an electronic device, the audio accessory comprising:
a first speaker;
a second speaker; and
a microphone, wherein the microphone is multiplexed with the second speaker.

7. The audio accessory of claim 6 further comprising a first switch, the first switch multiplexing the second speaker with the microphone.

8. The audio accessory of claim 7, the first switch is operated by a control signal transmitted through a control input, the control input being coupled to the first speaker.

9. The audio accessory of claim 7, wherein the first switch is selected from a group comprising an N-Channel Field Effect Transistor (N-FET), a P-Channel Field Effect Transistor (P-FET), an NC Relay, and a CMOS analog switch.

10. The audio accessory of claim 8, wherein the control signal operates a second switch, the second switch multiplexing the first speaker with the second speaker.

11. The audio accessory of claim 10, wherein the second controller is selected from a group comprising an N-Channel Field Effect Transistor (N-FET) and a P-Channel Field Effect Transistor (P-FET).

12. An electronic device comprising:
a detection circuit coupled to an audio input-output device; and
a control circuit coupled to the detection circuit,
the control circuit configures the electronic device in a stereo mode configuration and a mono mode configuration.

13. The device of claim 12, further comprising an audio signal module for providing audio signal feed to the audio input-output device, and receiving audio signal from the audio input-output device.

14. The device of claim 12, the detection circuit comprises a signal sampling module for sampling signals received from the audio input-out device.

15. A method for operating an audio accessory comprising a first speaker, a second speaker and a microphone, the method comprising:
receiving a control signal, the control signal set to a first value or to a second value;
configuring the audio accessory in a stereo mode configuration when the control signal is set to the first value; and
configuring the audio accessory in a mono mode configuration when the control signal is set to the second value.

16. The method of claim 15, configuring the audio accessory in the stereo mode configuration includes providing a stereo audio signal to the first speaker and to the second speaker.

17. The method of claim 16, providing the stereo audio signal to the first speaker over a first conductor and providing the stereo audio signal to the second speaker over a second conductor.

18. The method of claim 15, configuring the audio accessory in the mono mode configuration includes providing a mono audio signal to at least one of the first speaker and the second speaker using one of a first conductor and a second conductor.

19. The method of claim 18 further comprising providing the audio signal from the microphone to the first conductor or the second conductor.
